(19) United States
(12) Patent Application Publication
(10) Pub. No.: US 2009/0028383 A1
(43) Pub. Date: Jan. 29, 2009

(54) Method and Device for Monitoring the Transportation of a Number of Objects

(75) Inventor: Thomas Bayer, Virginia Water (GB)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/180,876

(22) Filed: Jul. 28, 2008

(30) Foreign Application Priority Data
Jul. 26, 2007 (DE) 102007034948.5

(51) Int. Cl. G06K 9/00

(52) U.S. Cl. 382/101

(57) ABSTRACT

The transportation progress of a number of objects that are provided with an identifier of a destination address, in particular mail items, are monitored. Each object passes through a sorting unit at least once. The sorting unit generates an image of the object and identifies the destination address of the object by evaluating the image. Each object is transported to the identified destination address. The sorting unit examines each object passing through the sorting unit within a predefined time period to determine whether or not the object has at least one predefined optically detectable characteristic. To this end the sorting unit evaluates the image of the object generated by the sorting unit. The sorting unit is connected to a database. The sorting unit only stores an image of an object in the database, if the object has the characteristic. The images stored in the database are evaluated according to a predefined evaluation criterion.

### CROSS-REFERENCE TO RELATED APPLICATION

This application claims the priority, under 35 U.S.C. § 119, of German application DE 10 2007 034 948.5, filed Jul. 26, 2007; the prior application is herewith incorporated by reference in its entirety.

### BACKGROUND OF THE INVENTION

### Field of the Invention

The invention relates to a method and device for monitoring the transportation of a number of objects, in particular mail items.

A method and a device of the generic kind are described in U.S. Pat. No. 6,697,500 B2 to Woolston et al. (cf. European published patent application EP 1345181 A2). There, there is disclosed a method for monitoring the transportation of a number of objects, with each object being provided respectively with an identifier of a destination address. According to that method, each object passes through a sorting unit at least once, the sorting unit generates an image of the object in each instance, the sorting unit identifies the destination address of the object by evaluating the image, each object is transported to the identified destination address, the sorting unit stores generated images in a database, and the images stored in a database are evaluated according to a predefined evaluation criterion.

The device described in U.S. Pat. No. 6,697,500 B2 and EP 1345181 includes a storage unit connected to the sorting unit, a database connected to the storage unit, and an evaluation unit connected to the database. The storage unit is configured to store generated images in the database, and the evaluation unit is configured to evaluate the images stored in the database according to a predefined evaluation criterion.

The objects described in the prior art reference are mail items, each provided with a delivery address. A sorting unit generates an image of each mail item and stores the image in a database. The stored images are then searched according to predefined criteria, in order to determine certain images. Evaluations are then carried out for the images thus determined.

This method has the disadvantage that very large quantities of data have to be processed. National postal services, for example, transport several thousand million mail items each day. Examining a single image of a mail item frequently takes one second computation time. The method described in the prior art reference U.S. Pat. No. 6,697,500 B2 and EP 1345181 A2 therefore requires a great deal of computation time among other things.

### SUMMARY OF THE INVENTION

It is accordingly an object of the invention to provide a method and device for monitoring the transport of a multiplicity of objects which overcomes the above-mentioned disadvantages of the heretofore-known devices and methods of this general type and which is still manageable even when a very large number of objects have to be transported.

With the foregoing and other objects in view there is provided, in accordance with the invention, a method of monitoring the transportation of a plurality of objects each provided respectively with an identifier of a destination address, the method which comprises the following steps:

passing each object through a sorting unit at least once;

with the sorting unit, generating an image of the object in each instance, and identifying the destination address of the object by evaluating the image;

transporting each object to the identified destination address;

wherein the sorting unit examines each object by evaluating the image of the object generated thereby to determine whether or not the object has at least one predefined optically detectable characteristic; and

an image of the object is only stored in a database, if the object has the predefined characteristic; and

evaluating the images stored in the database according to a predefined evaluation criterion.

With the above and other objects in view there is also provided, in accordance with the invention, a device for monitoring a transportation of a number of objects, each object being provided with an identifier of a destination address in each instance, and wherein the transportation includes:

passing each object through a sorting unit at least once;

wherein the sorting unit generates an image of the object in each instance; and

the sorting unit identifies a destination address of the object by evaluating the image;

whereupon each object is transported to the identified destination address;

the device comprising:

a storage unit connected to the sorting unit and a database connected to said storage unit, said storage unit being configured to store the images generated by the sorting unit in said database; and

an evaluation unit connected to said database, said evaluation unit being configured to evaluate the images stored in said database according to a predefined evaluation criterion;

a selection unit connected to the sorting unit and configured to examine each object by evaluating the image of the object generated by the sorting unit to determine whether or not the object has at least one predefined optically detectable characteristic; and

wherein said storage unit is configured to store an image of an object in the database if, and only if, the object has the characteristic.

The method allows the transportation of a number of objects to be monitored. Each object is provided with a respective identifier of a destination address.

Each object passes through a sorting unit at least once. This sorting unit generates an image of the object in each instance. By evaluating the image, the sorting unit identifies the destination address of the object. Each object is transported to the identified destination address.

The sorting unit examines each object passing through the sorting unit within a predefined time period, to determine whether or not the object has at least one predefined optically detectable characteristic. To this end the sorting unit evaluates the image of the object generated by the sorting unit.

The sorting unit is connected to a database. The sorting unit only stores an image of an object in the database if the object has the characteristic. The images stored in the database are evaluated according to a predefined evaluation criterion.

According to the invention images are only stored of those objects having a certain characteristic. This means that only images of interest are stored, rather than first storing all images and then searching for the images of interest at a later stage.

The method can be implemented in its entirety offline without influencing or having an adverse effect on the transportation of the objects.

A number of evaluations are preferably carried out in parallel. Each evaluation aims to store the images of objects having a certain characteristic. An identifier of said characteristic is also stored with each selected image. This allows different evaluations to be differentiated from one another.

Other features which are considered as characteristic for the invention are set forth in the appended claims.

Although the invention is described herein as embodied in method and device for monitoring the transportation of a number of objects, it is nevertheless not intended to be limited to the details shown, since various modifications and structural changes may be made therein without departing from the spirit of the invention and within the scope and range of equivalents of the claims.

### DETAILED DESCRIPTION OF THE INVENTION

In the exemplary embodiment the objects to be transported and examined are mail items. Each mail item is provided with delivery address data. The delivery address preferably specifies the recipient, as well as the street and house number or a PO box or a compartment in a parcel compartment system and a location.

Transportation is carried out with the aid of a number of sorting units of a transport agent. The transportation of a mail item starts in a posting location, e.g. a mail office or a mailbox. Initially the mail item passes through a sorting unit for the first time, specifically the sorting unit responsible for the posting location. The sorting unit identifies the delivery address and buffers it. The delivery address is assigned a delivery area, for example the area of a delivering mail office. For example the sorting unit prints a pattern of bars on the mail item, to code the delivery address.

A sorting unit is likewise responsible for the delivery area and therefore for the delivery address. The mail item passes through this second sorting unit. In this process the second sorting unit determines the buffered delivery address and initiates the transportation of the mail item to the delivery area.

In the exemplary embodiment both the first and second sorting units respectively generate an image of a surface of each mail item passing through the respective sorting unit. This image contains an image of the delivery address, provided on the mail item. The first sorting unit has an image management system IMS. The IMS carries out the following steps automatically:

The IMS activates the imaging systems, e.g. cameras, which generate the images of the mail items.

The IMS distributes the generated images to the image evaluation systems, which use optical character recognition to try to identify the respective delivery address automatically.

The IMS determines those images, for which the image evaluation systems were unable to identify the delivery addresses automatically and forwards these images to video coding stations. At the video coding stations processors evaluate the images manually and input delivery address data manually, for example by way of a keyboard and/or by voice input.

For each mail item the IMS determines which delivery address the image evaluation systems or video coding stations have determined and transmits this read result to the sorting unit.

An evaluation period is predefined. All mail items transported within this evaluation period are to be examined to determine whether they have a predefined characteristic. All mail items with the characteristic transported in the evaluation period are to be evaluated.

According to the invention the IMS also has a selection filter. The second sorting unit in the exemplary embodiment also has a selection filter. This selection filter is a software module, preferably integrated in the IMS as a plug-in. The selection filter receives an image of a mail item as the input value in each instance. The selection filter applies image processing methods to determine whether or not the mail item, from which the image originates, has a predefined characteristic. The selection filter preferably supplies a “1” if the mail item has the characteristic and a “0” if the mail item does not have the characteristic.

The selection filter does not intervene in the image processing set out above, this being carried out by the IMS described above. Thus the selection filter does not interfere with the work of the IMS or that of the imaging systems, image evaluation systems and video coding stations.

Methods for image processing and automatic pattern recognition in computer images are known for example from the following publications:

H. Niemann: “Klassifikation von Mustern” (Pattern classification), Springer-Verlag, 1983,

Jürgen Schurmann: “Pattern Classification: A Unified View of Statistical and Neural Approaches”, John Wiley & Sons, 1996.

The same selection filter is applied to all the images to be examined within the evaluation period. All the sorting units of the transport agent preferably apply the same selection filter, so that all mail items passing through at least one of the sorting units are examined using the same selection filters, regardless of which sorting units they pass through. The situation where different sorting units apply the same selection filter is preferably achieved in that each of said selection filters is a copy of the same original software module. It is also possible for each sorting unit to have the same selection filter and for this one selection filter to be stored on a central computer. Each sorting unit sends a prompt to the central computer, which activates the selection filter. The result (“1” or “0”) is transmitted to the requesting sorting unit.

All the transport agent's sorting units are connected to a central image evaluation database. Whenever the selection filter of a sorting unit supplies a “1” for an image of a mail item, the image is stored in the central evaluation database. If the selection filter supplies a “0”, the image is not stored in the central evaluation database. The respective mail item then does not have the predefined characteristic.

Generally only a small fraction of the mail items passing through the sorting units in the evaluation period have the predefined characteristic. Therefore only a fraction of all the images is stored in the central evaluation database and only this fraction has to be analyzed later.

A copy of the image is preferably stored in the central evaluation database. The image is preferably stored in the data format supplied by the IMS, in other words JPEG, TIF or run-length coding for example. The images can in particular be gray scale images or color images or even binary images.

In one embodiment the selected images are compressed before storage, to save storage capacity. However information can be lost during compression, for example because the compressed images have a lower resolution than the original images.

It should be made possible for the selected images to be evaluated according to any criteria—even according to criteria only determined at a later stage. Therefore the selected images are preferably not compressed before being stored in the central evaluation database. This avoids any loss of data, pixels or resolution.

The selection filter is preferably provided with an ID. This ID for example describes the characteristic, for whose presence or absence the selection filter examines an image. A selected image is stored in the central evaluation database together with a description. This description includes the ID of the selection filter, which selected the image.

The ID of the selection filter is preferably stored, because in a preferred embodiment a number of selection filters is used in parallel. This is described for an instance of two selection filters AF-1 and AF-2. The selection filter AF-1 examines an image of a mail item to determine whether or not the mail item has a predefined characteristic E-1. The selection filter AF-2 examines an image of a mail item to determine whether or not the mail item has a predefined characteristic E-2. The selection filter AF-1 is deployed in a predefined evaluation period AZ-1, the selection filter AF-2 in a predefined evaluation period AZ-2. The two evaluation periods AZ-1 and AZ-2 overlap. Because each image is stored with a description, which contains an ID for the selection filter, it can also be determined which characteristic the mail item, from which this image originates, has and which selection filter selected this image. It is possible for a mail item to have both characteristics E-1 and E-2.

The description, with which the image is stored, preferably also includes the delivery address of the mail item—or at least the identified part of the delivery address, for example the zip code. This delivery address was determined, as described above, by an image evaluation system or a video coding station and supplied to the IMS. This delivery address is then available when the selection filter selects the image and the image is therefore stored in the central evaluation database.

The images stored in the central evaluation database are evaluated according to a predefined evaluation criterion. This evaluation can take place at any time, e.g. after delivery of all mail items, from which these images originate. The evaluation can also be started during the evaluation period.

To carry out an evaluation, it is predefined which characteristic differentiates the mail items to be analyzed from all other transported mail items. The ID of this characteristic and therefore the ID of the selection filter examining images for the presence or absence of said characteristic is predefined for this purpose. All the images whose description contains this ID are automatically selected in the central evaluation database.

The selected images are then preferably evaluated by an analysis filter. This analysis filter receives the set of selected images, in other words the images of mail items with the predefined characteristic, as an input value. The analysis filter supplies the analysis result. For example the analysis filter supplies at last one of the following results:

The number of selected images and therefore the number of mail items having the predefined characteristic, and/or

a histogram showing a statistical distribution of one parameter of the selected mail items. This parameter is for example the respective location or the zip code of the delivery address or the addressee or even the respective transportation runtime of the mail item or the spatial distribution of delivery points in an area.

The analysis filter preferably outputs the analysis result in the form of an XML file. This embodiment simplifies the further processing of the analysis result.

The construction and method of operation of the invention, together with additional objects and advantages thereof will be best understood from the following description of specific embodiments of the inventive concept, which are described by way of example below.

In a first application it is to be determined how long transportation of a mail item takes on average. For this purpose a random sample of, say, 1000 mail items is generated and transported. Each mail item is posted in one mail office respectively and provided with a marking there. The mail item passes through two sorting units as described above and is delivered by a delivery operator.

Each mail item in the random sample is provided with a marking in the mail office where it is posted. This marking includes an optically detectable feature. In this application this feature is a two-dimensional code, in other words a matrix code. This matrix code stores the information when and at which mail office said mail item was submitted in coded form. The matrix code also includes an ID for said mail item. This ID differentiates the mail item from all other mail items in the random sample. The matrix code is configured so that it is only printed on the mail items in the random sample not on the other mail items transported by the transport agent.

With the invention it is not necessary to provide mail items with IDs, which differentiate the mail item from all other mail items to be transported by the transport agent in the evaluation period. As set out above, thousands of millions of mail items are transported in any given postal system every day. Such an ID would therefore be very long and complex to manage. There may not be sufficient space on a mail item to apply the matrix code. In contrast the random sample consists of for example 1000 mail items. The mail item ID only has to differentiate 1000 mail items, which is achieved with a sequence of four figures or ten bits.

The characteristic of the mail item in this application is the presence of a marking with a matrix code, which is only used for the random sample. The selection filter examines whether an image of such a matrix code is contained in an image of a mail item.

If the selection filter of a sorting unit determines that an image of a mail item has an image of such a matrix code, the time when said mail item passed through the sorting unit is also measured. The description of the image, which is stored together with the image in the central evaluation database, includes this time as well as the ID of the selection filter.

Each sorting unit of the transport agent is also provided with an ID. This ID differentiates the sorting unit from all other sorting units of the transport agent. The stored description of the image also includes an ID of the sorting unit, which generated the image.

Each mail item in the random sample passes through a sorting unit at least twice. If the mail item cannot be delivered and is sent back for example to the sender or to another predefined substitute delivery address, it passes through a sorting unit more often. Therefore at least two images of each mail item in the random sample are stored in the central evaluation database.

To determine the average runtime of mail items in the random sample, all the images having an ID of the selection filter applied are first selected. The analysis filter determines and decodes the matrix code in each selected image. In this process the analysis filter determines:

the ID of the mail item, which differentiates this mail item from all the other mail items in the random sample;

the mail office where this mail item was posted; and

the time when said mail item was posted at said mail office.

The analysis filter automatically determines from the stored description of the image the time when the mail item passed through the sorting unit, which generated said image. The path of the mail item to the delivery address can thus be tracked using the data set out above.

The analysis filter then has three times for each mail item in the random sample:

the time when said mail item was posted at said mail office,

the time when said mail item passed through a sorting unit for the first time, and

the time when said mail item passed through a sorting unit for the second time.

The analysis filter uses this information to generate a statistical statement about transportation runtimes. For example the analysis filter generates two histograms, showing the statistical distribution of the following two parameters:

the time interval between a mail item being posted and the time when said mail item passed through a sorting unit for the first time, and

the time interval between a mail item being posted and the time when said mail item passed through a sorting unit for the second time.

In one embodiment statistical evaluations are also carried out for those mail items, which were posted at specific preselected mail offices or which passed through specific sorting units.

In a second application the addressees are to be determined, to whom a specific sender X sends mail items within a predefined evaluation period. This evaluation is carried out for example for police purposes or in order to be able to initiate advertising measures. Of course requirements of the statutory data protection regulations have to be taken into account.

In this second application the characteristic of a mail item is the feature that the mail item originates from sender X. The sender provides the mail items he/she sends with sender data, e.g. with a specific logo and/or a specific wording and/or with his/her specific address. The selection filter determines whether this logo/wording/address of X appears in an image of a mail item. If so, the selection filter supplies a “1,” otherwise a “0”.

Each image of a mail item from sender X is stored together with a description in the central evaluation database. This description includes the delivery address identified by the sorting unit, through which the mail item passes for the first time. In the evaluation the analysis filter “collects” these delivery addresses. It generates statistical statements for example relating to parameters of these delivery addresses, e.g. the delivery location.

In a third application it is to be checked whether a major customer G of the transport agent has paid the correct amount for the transportation of mail items. The major customer G uses a franking machine or postage meter, which prints postage prepayment details on each mail item G sends. These postage prepayment details replace a stamp. The franking machine registers how many mail items from G the franking machine has printed. The major customer G pays the transport agent.

The franking machine is identified by an ID, e.g. a four-digit number. This ID differentiates the franking machine from all other franking machines registered with the transport agent.

The transport agent wishes to check whether the data relating to the postage prepayment details, which the franking machine transmits to the transport agent and for which the major customer pays correspond to the transportation charge payable for the mail items, which have actually been franked by said franking machine. It is to be checked in particular whether the major customer has paid the correct amount, whether there have been attempts at manipulation or whether a third party is using the ID of the franking machine for their own mail items without authorization.

The presence of postage prepayment details with this ID for G's franking machine is used as the characteristic of a mail item. In this application only a single image is required of each mail item sent by G. The sorting unit, which identifies the delivery address on a mail item from G, preferably also generates the image of said mail item and stores it in the central evaluation database.

The selection filter of this sorting unit examines whether the image of a mail item contains an image of postage prepayment details (and not for example an image of a stamp) and whether the predefined ID of G's franking machine is contained in said image of the postage prepayment details.

During the analysis in the simplest instance the analysis filter counts how many mail items the selection filter has selected. This measured number is compared with data from the major customer.

In a development of this third application the target transportation charge for each mail item from the major customer G is also determined. The sorting unit, which determines the delivery address of a mail item from G, also measures those parameters which are included in the determination of the transportation charge. These are generally the dimensions and/or weight of the mail item. Delivery region frequency can also influence the respective transportation charge. The description, which the sorting unit stores together with the image of a mail item from G in the central evaluation database, also includes these measured parameters of the mail item.

The analysis filter reads in the description with the measured parameters from the central evaluation database. It uses these parameters to calculate the target transportation charge for each mail item, which G has had transported by the transport agent in the evaluation period. From this the analysis filter calculates an overall target transportation charge for all the mail items, G has had transported by the transport agent in the evaluation period. This overall target transportation charge is compared with the transportation charge that G has actually paid for the franking machine in the evaluation period. If G has paid too little, the transport agent can prove the difference. The transport agent can use the stored images and the measured parameters of all mail items from G as additional proof. With this information the transport agent is able to prove the overall target transportation charge G should have paid. In particular with the aid of the images it is easier to check whether G him/herself has manipulated or whether a third party has used the ID of G's franking machine without authority.

In a fourth application the objects are items of baggage containing objects belonging to air passengers. The sorting unit is in the form of a baggage conveyor unit in an airport. This baggage conveyor unit comprises a read device, which x-rays the baggage items to discover objects in the baggage items, which should not be transported at all or at least not in hand baggage. The read device generates an image of objects in a baggage item. Security personnel examine these images visually.

The characteristic of a baggage item is the presence of objects of specific types in the baggage item. Objects of such types can be identified automatically in the image. For example all baggage items are to be selected in which at least one weapon is to be transported or a bottle containing a liquid.

The selection filter examines each image of a baggage item to determine whether it contains the contour of an object to be searched for type, e.g. the contours of a weapon or bottle.

During the evaluation the analysis filter for example counts how many such baggage items the selection filter has discovered. This number is compared with the results obtained in a check of the baggage items by security personnel. The analysis filter also determines parameters of objects of the searched for types. For example it determines approximately how much liquid was contained in a bottle in a baggage item. To this end it evaluates the contour of a bottle in the image of the baggage item.

1. A method of monitoring the transportation of a plurality of objects each provided respectively with an identifier of a destination address, the method which comprises the following steps:
passing each object through a sorting unit at least once;
with the sorting unit, generating an image of the object in each instance, and identifying the destination address of the object by evaluating the image;
transporting each object to the identified destination address;
wherein the sorting unit examines each object by evaluating the image of the object generated thereby to determine whether or not the object has at least one predefined optically detectable characteristic; and
an image of the object is only stored in a database, if the object has the predefined characteristic; and
evaluating the images stored in the database according to a predefined evaluation criterion.

2. The method according to claim 1, which comprises, with the sorting unit:
examining each object by also evaluating the image thereof to determine whether or not the object has at least one further predefined optically detectable characteristic; and
storing the image in the database if, and only if, the object has at least one of the predefined characteristic and the further predefined characteristic.

3. The method according to claim 1, which comprises, with the sorting unit, storing one identifier for each predefined characteristic associated with the object in addition to the image in each instance.

4. The method according to claim 1, which comprises passing each object through at least one of a plurality of sorting units used to transport the objects, and wherein:
the database is connected to each of the sorting units, and each sorting unit:
examines each object passing through the respective sorting unit to determine whether or not the object has the predefined characteristic; and
stores the image of an object having the predefined characteristic in the database.

5. The method according to claim 1, wherein each sorting unit is provided with a computer ID and the image of an object is stored in the database together with a specific ID of the sorting unit.

6. The method according to claim 1, which comprises providing at least one of the objects with a marking at the start of a transport thereof, wherein the marking has at least one optically detectable feature, and a presence or absence of a marking with the optically detectable feature is used as a characteristic of each object.

7. The method according to claim 6, which comprises marking the time at which the object is provided with the marking, wherein the optically detectable feature of the marking is an identifier of the time,
wherein the sorting unit:
measures the respective time when an object having a marking with a time identifier passes through the sorting unit;
stores an identifier of the time in the database together with the image of the object; and
wherein the step of evaluating the stored image includes the steps of:
determining the time when the relevant object was provided with the marking by evaluating the image; and
comparing the time with the time when the object passed through the sorting unit.

8. The method according to claim 1, which comprises determining a location at which the at least one object is provided with the marking, and wherein
the optically detectable feature of the marking is an identifier of the location and
the step of evaluating the stored image includes the steps of determining the location at which the relevant object was provided with the marking by evaluating the image.

9. The method according to claim 1, which further comprises counting, with the sorting unit, how many objects have the characteristic.

10. The method according to claim 1, wherein the objects are containers, each filled with at least one object, and wherein:
the sorting unit generates the image of each container such that the image shows each object in the container; and
the presence in the container of an object having a predefined optically detectable characteristic is used as a characteristic.

11. The method according to claim 1, wherein the presence of a predefined optically detectable symbol on a surface of the object is used as a characteristic of an object.

12. The method according to claim 1, wherein the predefined characteristic is a symbol represented by a predefined character sequence.

13. A device for monitoring a transportation of a number of objects, each object being provided with an identifier of a destination address in each instance, and wherein the transportation includes:
passing each object through a sorting unit at least once, and
the sorting unit generates an image of the object in each instance;
the sorting unit identifies a destination address of the object by evaluating the image, whereupon each object is transported to the identified destination address;
the device comprising:
a storage unit connected to the sorting unit and a database connected to said storage unit, said storage unit being configured to store the images generated by the sorting unit in said database; and
an evaluation unit connected to said database, said evaluation unit being configured to evaluate the images stored in said database according to a predefined evaluation criterion;
a selection unit connected to the sorting unit and configured to examine each object by evaluating the image of the object generated by the sorting unit to determine whether or not the object has at least one predefined optically detectable characteristic; and
wherein said storage unit is configured to store an image of an object in the database if, and only if, the object has the characteristic.

14. The monitoring device according to claim 13, wherein said selection unit is a first selection unit and a second selection unit
is connected to the sorting unit and
is configured to examine each object by evaluating the image thereof to determine whether or not the object has at least one further predefined optically detectable characteristic, and
said storage unit is configured only to store an image of an object in the database, if the object has at least one of the two predefined characteristics.

15. An assembly, comprising:
a sorting unit configured to have each of a plurality of objects being transported pass therethrough; and
a monitoring device according to claim 13 connected to said sorting unit;
said sorting unit including:
an imaging system configured to generate an image of each object passing through said sorting unit in each instance; and
an image evaluation system configured to identify the destination address, with whose identifier an object is provided, by evaluating the image of the object; and
wherein said sorting unit is configured to initiate transportation of an object to the identified destination address.

16. The arrangement according to claim 15, wherein said sorting unit is one of a plurality of sorting units, and said monitoring device is connected to a each of said plurality of sorting units.
